(19) United States
(12) Patent Application Publication
(10) Pub. No.: US 2025/0191822 A1
(43) Pub. Date: Jun. 12, 2025

(54) APPARATUS AND METHOD FOR MAGNETISING MATERIALS

(71) Applicant: DRY TAIL IP PTY LTD, Kensington Gardens, South Australia (AU)

(72) Inventor: Ian KUCHEL, Kensington Gardens (AU)

(73) Assignee: DRY TAIL IP PTY LTD, Kensington Gardens, South Australia (AU)

(21) Appl. No.: 18/856,419

(22) PCT Filed: Apr. 14, 2023
(86) PCT No.: PCT/IB2023/053858

§ 371 Date: Oct. 11, 2024

(30) Foreign Application Priority Data
Apr. 14, 2022 (AU) 2022900996

(51) Int. Cl. H01F 13/00

(52) U.S. Cl. CPC H01F 13/00

(57) ABSTRACT

An apparatus is disclosed for inducing magnetism in a flowstream of at least partially magnetisable, dry particulate feed material, in order to effect a subsequent particle classification. The dry separation stage is located proximal to the magnetic induction apparatus, in the form of a treatment chamber 10 with a plurality of spaced-apart magnets 16, 18 located adjacent to, and moveably displaceable along the length of both an upper and a lower side region of the treatment chamber 10, to generate a localised magnetic induction field zone. Conveyer belts 22, 24 carrying the dry particles move across each of the outer faces of the magnets 16, 18 on both sides of the chamber 10, but at differential relative velocities to each other, creating a region of air-particle fluidisation and agitation within the treatment chamber 10 and then a physical separation of the particulate feed material can occur based upon their susceptibility to magnetic induction.

### TECHNICAL FIELD

This disclosure relates generally to the field of processing magnetic materials and, more particularly, to methods and apparatus for magnetising dry, crushed mineral ores to enhance the efficiency of separation of certain minerals. The disclosure is concerned with the design of a magnetising apparatus as well as methods for optimising the performance of the apparatus in separating certain crushed particulate ore material, such as iron ores.

### BACKGROUND OF THE DISCLOSURE

Magnetic separators for mineral processing fall into three basic categories: low, medium and high intensity, the rating being based on the relative magnetic field strength employed. The following magnetic separators are commonly used: WHIMS (wet high intensity magnetic separators) and LIMS (wet/dry low intensity magnetic set magnetic drums).

In each case, the difference in the magnetic properties of the various ore minerals, otherwise known as their magnetic susceptibility, will determine their response to being exposed to a magnetic field.

Magnetic separation can be used to separate valuable ferromagnetic minerals from non-magnetic gangue, for example to separate magnetite iron ore (with high magnetic susceptibility) from quartz. Other ferromagnetic minerals include those which contain iron, nickel and cobalt. The process can also be used to remove magnetic contaminants from other valuable minerals.

The magnetic susceptibility of other materials may be divided into two groups. Paramagnetic materials are attracted to the magnetic field, and those that are repelled by a magnetic field are called diamagnetic materials. Paramagnetic minerals which are of commercial interest include ilmenite, siderite, chromite, hematite, wolframite.

Known magnetic separators can be operated either dry or wet. Currently available magnetic classification equipment normally requires the prior crushing a run-of-mine mineral orebody down to a particulate top-size of minus 100 μm which may involves producing a wet slurry and, in the event that a dry particulate ore is being passed into a magnetic classification apparatus, it will likely require the introduction of air.

Whilst having a crushed feed ore material is fundamental for use in a magnetic separator, in most comminution machines there is little or no control on which particles are broken. The tendency is for over-grinding followed by use of a post-equipment classification device (such as a screen or cyclone or air classifier) to direct certain particulates onward for further processing, as well as to direct those particulates which need to be recycled to move back upstream for further breakage. Comminution conducted in this manner inevitably leads to over-grinding of a large portion of the material, to a particulate size which is actually below the minimum product top-size needed for effective liberation of the valuable minerals, at great cost.

In particular, those size classifiers that suspend particles in air or water suffer from “selection by density” as well as selection by particulate size, leading to further over-grinding of the denser phase (such as the high-density magnetite mineral) and under-grinding of the lower density phase. As a result, considerable energy is wasted in over-grinding material, leading to a higher cost in terms of energy usage than was needed to achieve the desired liberation size.

It would be useful to be able to provide an improved magnetic separation apparatus and method which can operate effectively using a relatively coarse particulate feed material stream, and therefore avoid the requirement to overgrind the source feed material upstream of the magnetic separator. In turn, this can mean a dry material handling process is possible. Avoiding overgrinding can reduce operational costs to do with crushing, grinding and milling, and also minimise the requirement of the downstream system to either handle finely-sized feed material in a wet slurry form (requiring pumps and other slurry handling equipment, at an increased operational cost), or alternatively, to convey dry, finely-sized feed material using an airflow stream (which naturally produces dust, increases feed losses, and is expensive to operate).

It would be useful to be able to provide an improved magnetic separation apparatus and method which can operate effectively to recover a large proportion of the valuable ferromagnetic and paramagnetic materials which may be present in a particulate feed material stream, and with as clean a separation as possible from the diamagnetic contaminants, while using a particle size which achieves mineral ‘liberation’ without overgrinding.

### SUMMARY OF THE DISCLOSURE

In a first aspect, embodiments are disclosed of an apparatus arranged for inducing magnetism in a flowstream of at least partially magnetisable, dry particulate feed material, in order to effect a subsequent particle classification thereof, in use the flowstream being fed into a dry separation stage which is located proximal to said magnetic induction apparatus, the apparatus comprising:
a treatment chamber with an inlet and an outlet, through which said flowstream respectively enters and exits the treatment chamber; and
a plurality of spaced-apart magnetic sources located adjacent to, and moveably displaceable along the length of both an upper and a lower side region of the treatment chamber, such that, during said movement, a respective magnetic source from each of the upper and lower side regions forms a pair of magnetic sources which are aligned in opposing relation to one another, and laterally spatially positioned apart with respect to one another, in use each of said pairs of magnetic sources generating a localised magnetic induction field zone; and
said upper side region of the treatment chamber being defined by at least one of a moveable first surface element which is configured in use to move over a face of said spaced-apart magnetic sources which are located thereabove, and said lower side region of the treatment chamber being defined by at least one of a moveable second surface element which is configured in use to move over a face of the spaced-apart magnetic sources which are located therebelow;
wherein during operation of the apparatus:
the second surface element transports the flowstream of dry particulates into the treatment chamber via the inlet; and
once inside the treatment chamber, the relative rate of motion of the first surface element with respect to the magnetic sources at the upper side region of the chamber is greater than the relative rate of motion of the second surface element with respect to the magnetic sources at the lower side region of the chamber, thereby creating a region of air-particle fluidisation and agitation within the treatment chamber due to physical separation of the particulate feed material from the second surface element; and
the combined effect of air-particle fluidisation and agitation during exposure to said localised magnetic induction field zones generated by said respective pairs of magnetic sources, results in a physical classification of said particulates, based upon their susceptibility to magnetic induction, such that:
   a feed material fraction with high susceptibility to magnetisation is retained at the first surface element due to a preferential attraction to the spaced-apart magnetic sources which are located at the upper side region of the treatment chamber;
   a feed material fraction with medium susceptibility to magnetisation is repelled by the pairs of spaced-apart magnetic sources which are located at both the upper and lower side regions of the treatment chamber, ultimately is retained at the second surface element in regions of low magnetic intensity located between the pairs of spaced-apart magnetic sources in the treatment chamber; and
   a feed material fraction with low susceptibility to magnetisation is ultimately retained at the second surface element in a region adjacent the spaced-apart magnetic sources which are located at the lower side region of the treatment chamber to which it is attracted, as well as due to repulsion by the spaced-apart magnetic sources which are located at the upper side region of the treatment chamber.

In some embodiments, the plurality of spaced-apart magnetic sources located adjacent to the upper and lower side region of the treatment chamber are moveably displaceable in the same direction, in use. In one form of this, the axial direction of movement of a row of the upper side and the lower side magnets is substantially the same, so that the magnets comprising the spaced-apart pairs of magnets are moved whilst being in at least partial facing alignment with one another, to travel from one end of the treatment chamber to the other in the same linear direction.

In yet other forms, the spaced-apart pairs of magnets can be moved in at least a partial facing alignment with one another, but whilst the axial direction of movement of a row of the upper side and the lower side magnets is substantially linear, these axial directions may be at an angled orientation to one another, to create other forms of localised magnetic induction field zone.

In some embodiments, each pair of magnetic sources is laterally spatially positioned apart with respect to one another by a pre-determined distance therebetween. In one form of this, an equal lateral spatial distance between the opposing end faces of the pairs of magnets applies over the whole length of the treatment chamber, as the two rows of magnets each move along a parallel planar surface. That pre-determined lateral distance between those magnet pairs is chosen depending on the particulate matter to be treated, to provide the desired level of magnetic field intensity between the opposing magnets, as well as to provide for a sufficient (but not a complete) reduction of the magnetic field intensity in the spaces between the adjacent magnet pairs as they move along the length of the treatment chamber.

In some other forms, the faces of the two rows of magnets (and the relative position of the first and second surface elements which move thereacross) may be arranged so as to slightly diverge from one another if necessary, over the length of the treatment chamber, for example if a heavy build-up of deposited magnetised material is likely to occur in use on the opposing surfaces of the upper and lower support elements which face into the treatment chamber. One way to achieve this is for the magnet pairs to be arranged with their opposing end faces progressively positioned further apart from one another when moving across the length of the treatment chamber, for example by arranging for one or both of the opposing magnet pairs to be gradually recessed into their respective mountings.

In one example of such an arrangement, the magnets on the upper side and the lower side of the treatment chamber are still in at least partial facing alignment with one another, and travel in the same linear direction. However, whilst the axial direction of movement of a row of the upper side and the lower side magnets is substantially linear, the axial direction of the support member which moves across said declining upper faces of the magnets located on the respective upper and lower sides of the treatment chamber may be at a divergent, angled orientation with respect to one another.

In some embodiments, the plurality of spaced-apart magnetic sources located adjacent to both the upper and lower side regions of the treatment chamber are respectively operably coplanar whilst being laterally spatially positioned apart with respect to one another by a single, pre-determined distance therebetween.

In one exemplary form of this, the lateral spatial distance between the opposing end faces of the pairs of magnets can be approximately 50 millimetres over the whole length of the treatment chamber, as the two rows of magnets each move along a parallel planar surface.

In another exemplary form of this, the lateral spatial distance between the opposing end faces of the pairs of magnets can be approximately 20 millimetres over the whole over the whole length of the treatment chamber.

In some embodiments, the plurality of spaced-apart magnetic sources are connected to a respective moveable support element, operable in use to move the magnetic sources along the length of the upper and/or lower side regions of the treatment chamber by means of an associated drive mechanism, wherein the moveable support element(s) and associated drive mechanism(s) are connected to a frame which is positioned in fixed relation to the treatment chamber.

In one form of this, at least one of the moveable support elements is operably moveable by means of an adjustment mechanism, in use to adjust the lateral spatial distance between the magnetic sources which are aligned in opposing relation with respect to one another at the treatment chamber, in use to reduce the intensity of the localised magnetic field zones therebetween. For example, using this adjustment mechanism to alter the lateral spatial distance between aligned pairs of magnetic sources can be achieved by lowering the relative position of the magnetic sources located at the lower side region of the treatment chamber by 30 millimetres, thereby expanding the pre-determined lateral spatial distance between the rows of magnets from, say, 20 millimetres up to 50 millimetres. Lowering the position of the magnetic sources located at the lower side region of the treatment chamber in effect can mean adjusting the position of their moveable support element downward in relation to the frame.

In other embodiments, altering the lateral spatial distance between aligned pairs of magnetic sources can also be achieved by lowering the relative position of the magnetic sources located at the lower side region of the treatment chamber, in combination with raising the position of the magnetic sources located at the upper side region of the treatment chamber, or as a further alternative, only raising the position of the magnetic sources located at the upper side region of the treatment chamber. Both of these options will result in an expansion of the pre-determined lateral spatial distance between the rows of magnets from, say, an exemplary 20 millimetres gap, up to say, an exemplary 50 millimetre gap therebetween.

Of course, in situations where there is a requirement in use to increase the intensity of the localised magnetic field zones between the magnetic sources which are aligned in opposing relation with respect to one another at the treatment chamber, the reverse action applies in which one, or the other, or both, of the moveable support elements can be operably moved by use of its respective adjustment mechanism(s), to reduce the lateral spatial distance therebetween.

An alternate way to effect a decrease in the intensity of the localised magnetic field zone between each magnetic source pair which are aligned in opposing relation with respect to one another at the treatment chamber, is to re-position the moveable support element in relation to the position of the second surface element. In some embodiments the lower side region of the treatment chamber is defined by the moveable second surface element which is configured in use to move over a face of the spaced-apart magnetic sources, which are located immediately therebelow, and be supported by them. In many embodiments, there is only a small lateral distance between the moveable second surface element and the adjacent face of the spaced-apart magnetic sources.

However, in some other embodiments, the moveable support element which is used to move the magnetic sources along the length of the lower side region of the treatment chamber is operably moveable by means of an adjustment mechanism, in use to adjust the lateral spatial distance of those magnetic sources with respect to the second surface element, to thereby reduce the intensity of the localised magnetic field zone experienced at the second surface element, provided that the second surface element remains in its original location. The inventor has observed that if the magnetic sources at the lower side region of the treatment chamber were moved downwardly so as to be offset below the second surface element, by even a small distance, the magnetic field strength experienced by particulates at that second surface element was far less than the very intense field strength which remains on particles located at the upper surface element. In some exemplary embodiments, the inventor has established that an offset of as little as 5 to 15 mm is sufficient to cause the field strength at the second surface element to be far less than the very intense field strength at the first surface element.

In some embodiments, the plurality of pairs of magnetic sources which are aligned in opposing relation with respect to one another at the treatment chamber, and which deliver the highest intensity of localised magnetic field zones thereat, are spaced at a pre-determined distance apart from an adjacent magnetic source along the length of each respective moveable support element, such that in use, a zone of relatively low magnetic intensity is operably achieved midway along that predetermined distance between each of the adjacent pairs of magnetic sources.

As mentioned, in use a high intensity induced magnetic field zone extends over the lateral spatial distance between each pair of magnetic sources. The pre-determined distance between the adjacent pairs of magnetic sources needs to be sufficient so that a zone of low magnetic intensity prevails midway between the zones of high magnetic intensity, with at least some induced magnetic field intensity being present (and not zero magnetic intensity). The particles of low magnetic susceptibility find themselves separated (usually by repulsion) away from the high magnetic intensity zones located between the opposing pairs of magnetic sources, and have a tendency to migrate to a zone of low magnetic field intensity located between those zones of high intensity.

As previously mentioned, there are also ways to further reduce the intensity of the localised magnetic field zone experienced at the second surface element by repositioning the support element, which holds the magnets near the lower side region of the support chamber, to a position which is offset from the second surface element.

A zone of low magnetic field intensity advantageously provides sufficient induced magnetism to retain the fine particulates of low magnetic susceptibility at that second surface element, thereby also limiting the generation of airborne dust particles exiting the treatment chamber. In practice, this means that zones of low magnetic field intensity will be created if there is a spacing between the adjacent pairs of magnetic sources of around 100 to 150 mm from each other, depending on the magnetic strength employed for the particulate material being separated.

In some embodiments, each moveable support element comprises an endless loop of a support material which is operably connected to at least two moveable support roller(s) about which the endless loop turns, and wherein each endless loop is operated by an associated drive mechanism in use. In one form, the two support elements are located directly one above the another in use, with a lateral spatial distance therebetween, forming the height of the treatment chamber. When viewed from above, the respective area of overlap of the two support elements is associated with the uppermost and lowermost planar dimensions of the treatment chamber.

In some forms, the support material of the endless loop can comprise a ribbed skeleton structure of wire or cable mesh, made of a material that is sufficiently flexible to be both taut, so as to form a sturdy support for the magnetic sources, as well as being able to be deformed while being moved through a 180-degree angle turn moving around each of the terminal end rollers, in use. In one form, each magnetic source is each retained at a respective support element by firstly being located in a support bracket of similar shape and configuration, which itself is securely joined to the support material using a fastener, or in another form the support bracket is integrally formed therewith.

In some embodiments, the plurality of spaced-apart magnetic sources located adjacent to the upper and the lower side regions of the treatment chamber are moveably displaceable at the same relative rate of motion in use, so as to create an arrangement of aligned pairs of magnetic sources which move together in relation to the treatment chamber. In order to create the most intense localised magnetic field zone between the magnetic sources on each of the moveable support elements, they need to move in opposing alignment with one another, so it means they need to move at the same speed, and in some embodiments, be displaceable in the same general linear direction, in use.

In some embodiments, the, or each, of the first and second surface elements are moveably displaceable in the same direction, in use, being the same linear direction. In some embodiments, the maximum lateral spatial distance between the first and second surface elements with respect to one another is determined by the spatial position of the plurality of magnetic sources at the upper and lower side regions of the treatment chamber, since the respective first and second surface elements are arranged to slidingly move over an exposed face of each magnetic source.

In some embodiments, the, or each of the, first and second surface elements comprise an endless loop which is operably connected to a respective moveable support means, operable in use to move said surface elements along the length of the upper and/or lower side regions of the treatment chamber by means of an associated surface element drive mechanism, wherein the moveable support means and associated drive mechanism are connected to a frame which is positioned in fixed relation to the treatment chamber.

In some embodiments, each moveable support means comprises an endless loop of a support material which is operably connected to at least two moveable support roller(s) about which the endless loop turns, and wherein each endless loop is operated by the associated surface element drive mechanism in use.

In some embodiments, the, or each, first and second surface elements are moveably displaceable in the same direction, in use.

In some embodiments, the, or each, first and second surface elements are formed from a resilient, hard-wearing material of construction, capable of supporting abrasive finely powdered ore material.

In some embodiments, the, or each of the, first surface element(s) is moveably displaceable at a rate of motion which is approximately 0.2-1.0 metres/second faster than the rate of motion of the spaced apart magnetic sources at the upper side region of the treatment chamber.

In some embodiments, the, or each of the, second surface element(s) is moveably displaceable at a rate of motion which is approximately 0.0-0.2 metres/second faster than the rate of motion of the spaced apart magnetic sources at the lower side region of the treatment chamber.

In some embodiments, the plurality of spaced-apart magnetic sources includes permanent magnetic materials.

In some embodiments, the plurality of spaced-apart magnetic sources are formed of electromagnetic materials which are externally powered in order to induce magnetism, in use.

In some embodiments, the feed material fraction with high susceptibility to magnetisation includes ferromagnetic particulate materials, the feed material fraction with medium susceptibility to magnetisation includes diamagnetic particulate materials, and the feed material fraction with low susceptibility to magnetisation includes paramagnetic particulate materials.

In some embodiments, the feed material fraction with low susceptibility to magnetisation may include paramagnetic particulate materials which also contain unliberated ferromagnetic and/or diamagnetic material therewithin.

In some embodiments, the feed material fraction with high susceptibility to magnetisation is caused to be physically separated from the first surface element in a region outside of the treatment chamber, and once there are no spaced-apart magnetic sources located adjacent thereto.

In some embodiments, the feed material fraction with medium susceptibility to magnetisation is caused to be physically separated from the second surface element in a region outside of the treatment chamber, and once there are no spaced-apart magnetic sources located adjacent thereto.

In some embodiments, the feed material fraction with low susceptibility to magnetisation is caused to be physically separated from the second surface element in a region adjacent to, but outside of the exit of the treatment chamber, where the endless loop turns to travel in an opposite direction.

In further embodiments, instead of an open framework, the support for each of the functional units may be present in other forms, such as a planar baseplate with the necessary orifice through which the flow path is directed in use, and with respective baseplates having some other means (such as legs, flanges or other projections) for being joined in a fixed spatial relationship directly to one another, or alternatively being fastened onto an exo-skeleton type of structure.

In this specification, when the term “stack” is used, it refers to a plurality of the aforementioned magnetic classification stages, placed adjacent to one other and functionally interconnected to form a rigid structure.

In use, the dry particulate solids are passed slowly, for example via a suitable feeder inlet device such as a vibratory feeder, onto the uppermost surface of the second surface element.

In the disclosed method, the feed particulate material (in the form of a stream of particles with a relatively large top-size compared with most magnetic separation equipment) is passed as a thin layer in between the opposing pairs of magnets that form the magnetic induction treatment chamber of the machine.

Throughout this specification, when the term “top-size” is used, it refers to the proportion of solid particulates which are present in a feed material which have a minimum width greater than the predetermined dimension of a selected crushed particle size, typically annotated as P80% passing 100 μm, in other words, 80% of the particulates were smaller than 100 μm, and 20% were coarser.

In a second aspect, embodiments are disclosed of a method for inducing magnetism in a flowstream of at least partially magnetisable, dry particulate feed material, and effecting a subsequent particle classification thereof using a dry separation apparatus which is located proximal to a magnetic induction apparatus, wherein said apparatus comprises:
a treatment chamber with an inlet and an outlet, through which said flowstream respectively enters and exits the treatment chamber in use; and
a plurality of spaced-apart magnetic sources located adjacent to, and moveably displaceable along the length of, both an upper and a lower side region of the treatment chamber, arranged in use so that when pairs of laterally separated magnetic sources, one from each of said upper and lower side regions, are located in opposing facing alignment with one another, a localised magnetic induction field zone is generated therebetween; and
a first surface element which, in use, moves over faces of the plurality of spaced-apart magnetic sources located at the upper side region, and a second surface element which, in use, moves over faces of the plurality of spaced-apart magnetic sources located at the lower side region
the method comprising the steps of:
following a transfer of particulate feed material onto the second surface element, causing said second surface element to transport said flowstream of particulate feed material into the treatment chamber via the inlet; and
setting the rates of motion of
   (a) the first surface element
   (b) the magnetic sources at the upper side region of the chamber,
   (c) the second surface element, and
   (d) the magnetic sources at the lower side region of the chamber, so that the relative rate of (a) to (b) is greater than the relative rate of (c) to (d), thereby creating region(s) of air-particle fluidisation and agitation within the treatment chamber, due to physical separation of the particulate feed material from the second surface element;
wherein the combined effect of air-particle fluidisation and agitation during exposure to said localised magnetic induction field zones generated by said respective pairs of magnetic sources, results in a physical classification of said particulates, based upon their susceptibility to magnetic induction, such that:
   a feed material fraction with high susceptibility to magnetisation is retained at the first surface element due to a preferential attraction to the spaced-apart magnetic sources which are located at the upper side region of the treatment chamber;
   a feed material fraction with medium susceptibility to magnetisation is repelled by the pairs of spaced-apart magnetic sources which are located at both the upper and lower side regions of the treatment chamber, and ultimately is retained at the second surface element in a region of low magnetic intensity located between the pairs of spaced-apart magnetic sources in the treatment chamber; and
   a feed material fraction with low susceptibility to magnetisation is ultimately retained at the second surface element, in a region adjacent the spaced-apart magnetic sources which are located at the lower side region of the treatment chamber to which it is attracted, as well as due to its repulsion by the spaced-apart magnetic sources which are located at the upper side region of the treatment chamber.

In some embodiments of this aspect, the use of the features of the apparatus arranged for inducing magnetism in a flowstream of the first aspect, may form steps for performing the method of the present aspect.

Aspects, features, and advantages of this disclosure will become apparent from the following detailed description when taken in conjunction with the accompanying drawings, which are a part of this disclosure and which illustrate, by way of example, principles of any inventions disclosed.

### DESCRIPTION OF THE FIGURES

The accompanying drawings facilitate an understanding of the various embodiments which will be described:

FIG. 1 is a side, schematic view of an embodiment of an apparatus for inducing magnetism in a flowstream of dry particulate material, and effect a subsequent particle classification thereof, illustrating the principle of operation of the dry separation stage and the magnetic induction apparatus in a single stage treatment, in accordance with the invention.

FIG. 2 is a front, perspective, exploded view of some of the components used in the operation of the magnetic induction apparatus, as shown in FIG. 1.

FIG. 3 shows an end perspective, side view of an embodiment of an apparatus for inducing magnetism in a flowstream of dry particulate material, and effect a subsequent particle classification thereof, illustrating the combination of a dry separation stage and the magnetic induction apparatus in a single stage treatment, in accordance with the invention.

FIG. 4 shows top, side view of part of the embodiment of an apparatus for inducing magnetism in a flowstream of dry particulate material, and effect a subsequent particle classification thereof, as shown in FIG. 3.

FIG. 5 is a side, schematic view of an embodiment of an apparatus for inducing magnetism in a flowstream of dry particulate material, and effect a subsequent particle classification thereof, illustrating the principle of operation of the dry separation stage and the magnetic induction apparatus in a single stage treatment, in accordance with the invention.

FIG. 6 illustrates a flow chart of the process steps involved in the separation and recovery of magnetite mineral when using the apparatus for inducing magnetism in dry particulate material for improved particle classification, in accordance with the invention.

FIG. 6A illustrates a flow chart of the process steps involved in the separation and recovery of magnetite mineral along with the additional steps for the separation and recovery of hematite mineral, using the apparatus for inducing magnetism in dry particulate material for improved particle classification, in accordance with the invention.

FIG. 7 illustrates a flow chart of the process steps involved in the separation and recovery of paramagnetic minerals, by using the apparatus for inducing magnetism in dry particulate material for improved particle classification to separate one or more of the following paramagnetic minerals: ilmenite, rutile, wolframite, chromite, and to reject diamagnetic minerals therefrom such as silica gangue, in accordance with the invention.

### DETAILED DESCRIPTION

This disclosure relates to the features of a novel apparatus and method for the magnetisation and then separation of particulate solids, based upon differences in their susceptibility to magnetisation, for example primary-crushed mineral ore from a mine. In the past, such ores were only subjected to basic, known magnetic separation methods and process equipment.

The disclosure also relates to a method of operating and controlling the apparatus to achieve the necessary separation of mineral species, whilst minimising the quantity of energy consumed upstream involving particle size reduction. As a result of its configuration, the machine can be operated using coarser size feed particulates which, in turn, minimises the tendency to overgrinding of the solid particulate feed when compared with other known ore separation apparatus in the field.

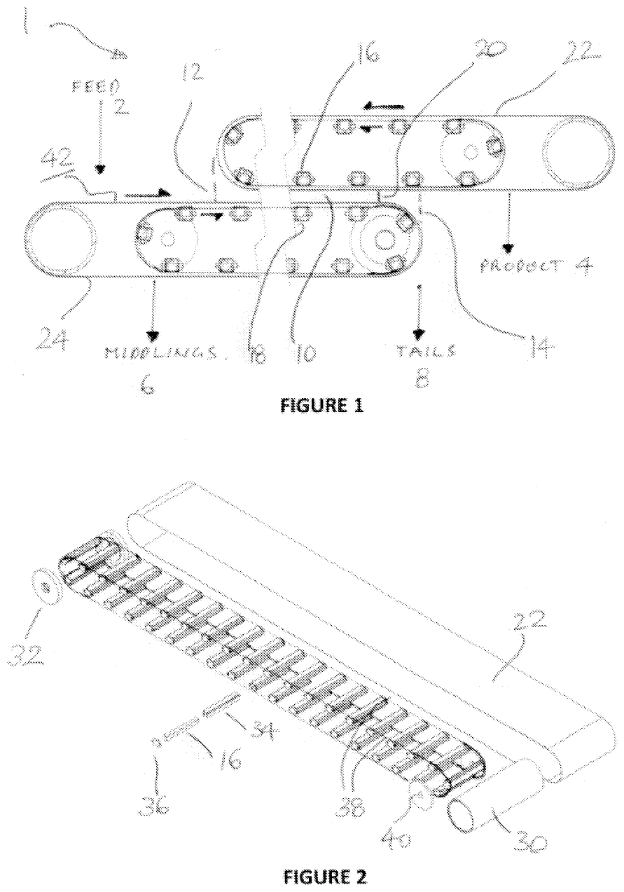

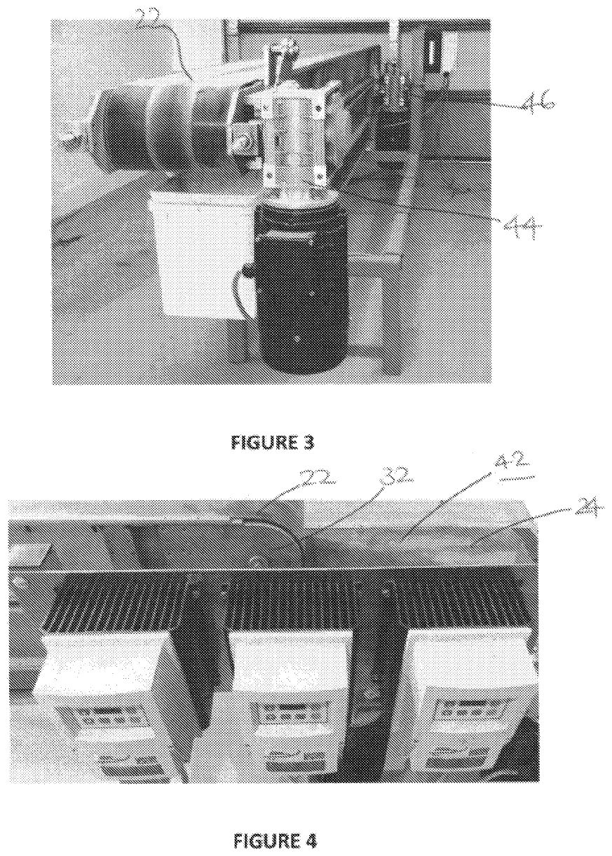

Referring to the drawings, the apparatus shown in FIG. 1 is an embodiment of a single stage dry particle separation machine, which can form part of a multi-stage dry particle separation and magnetisation machine. In practice, a multi-stage machine may comprise a plurality of such separation stages, arranged in series for repeated treatment of a mineral ore particulate feed material, to provide more exposure time to localised magnetic field zones for the particulate feed material.

In some embodiments, different stages in a sequence may be arranged to apply different intensity levels of magnetic fields to the particulate feed material being treated, for example the intensity level from stage to stage may be arranged to increase, starting from an initial low level, aimed at a more gradual separation of magnetised components. A sequence of stages may each be connected by appropriate chutes, pipes and conveyer systems, all being linked in a manner to facilitate the travel of particulate feed materials therethrough. The stages may be located on a common support structure, and may, for example, be located above one another to economise on floor space.

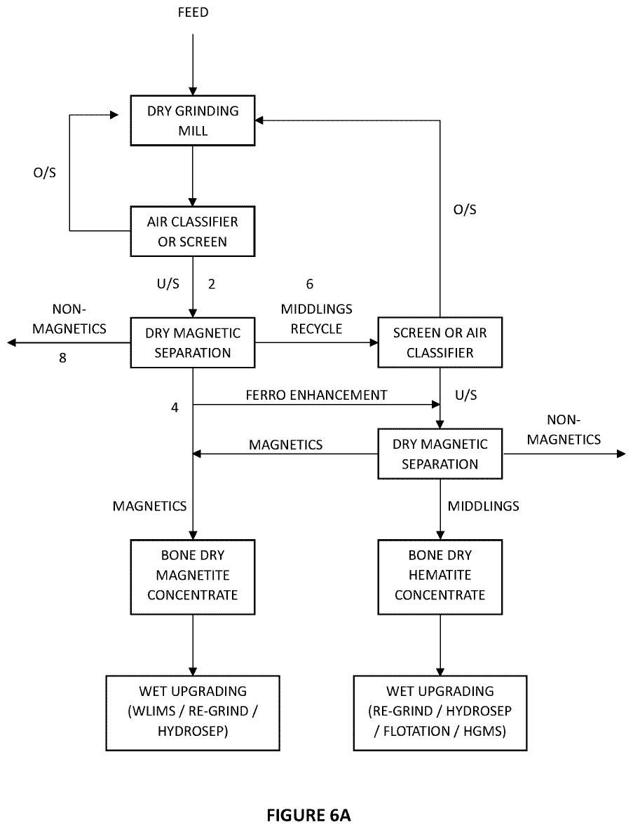

As shown in FIG. 1, a magnetic treatment chamber 10 is defined by a thin planar-shaped region in which pairs of magnetic sources 16, 18 are laterally spatially positioned apart with respect to one another by a pre-determined distance 20. As shown in FIG. 1 and FIG. 5, the same lateral spatial distance 20 between the opposing end faces of the pairs of magnets 16, 18 applies over the whole length of the treatment chamber 10, and the region is only functional as a magnetic treatment chamber while rows of such magnets 16, 18 are each caused to move along an exemplary parallel planar surface on either side of the chamber 10.

The pre-determined lateral distance 20 between those magnet pairs 16, 18 is chosen depending on the particulate matter to be treated, to provide the desired level of magnetic field intensity between the opposing magnets 16, 18. The magnetic field strength chosen also needs to provide for zones of low magnetic field intensity in the lateral spaces between adjacent magnets on each side of the treatment chamber 10, in the same plane of movement as the belts 22, 24.

In the embodiment shown in FIG. 1, the plurality of spaced-apart magnetic sources 16 located adjacent to the respective upper side region of the treatment chamber 10 are respectively operably coplanar and laterally spatially positioned apart from a respective magnetic source 18 by a single, pre-determined distance therebetween 20, for example.

In one exemplary form of this, the lateral spatial distance 20 between the opposing end faces of the pairs of magnets 16, 18 can be approximately 20-50 millimetres over the whole length of the treatment chamber 10, as the two rows of magnets 16, 18 each move along respective, parallel planar surfaces. The entry 12 and the exit 14 points of the treatment chamber 10 are located when the alignment between those opposing magnet pairs 16, 18 ends (as one of the magnets is caused to rotate away from respective other magnet of the pair)

A localised, induced field of magnetism can influence an ore material or mineral mixture which comprises at least some partially magnetisable, dry particulates in that ore material, and cause a particle classification thereof when the flowstream of the material is fed into a dry separation stage which is located proximal to said magnetic induction apparatus.

The two sets of spaced-apart magnetic sources 16, 18 are moveably displaceable in the same direction during use when the connected to a respective moveable support element, by means of an associated drive mechanism, wherein the moveable support element(s) and associated drive mechanism(s) are connected to a frame which is positioned in fixed relation to the treatment chamber 10.

The plurality of spaced-apart magnetic sources 16, 18 located adjacent to the upper and lower side region of the treatment chamber 10 are moveably displaceable in the same direction, in use, as shown by the arrows in FIG. 1 and FIG. 5, for example.

In some forms, the support material of the endless loop can comprise a ribbed skeleton structure of wire or cable mesh, made of a material that is sufficiently flexible to be both taut, so as to form a sturdy support for the magnetic sources, as well as being able to be deformed while being moved through a 180-degree angle turn moving around each of the terminal end rollers, in use. In one form, each magnetic source is each retained at a respective support element by firstly being located in a support bracket of similar shape and configuration, which itself is securely joined to the support material using a fastener, or in another form the support bracket is integrally formed therewith.

The first and second surface elements are each present in the form of conveyer belt strips which are formed from rubber or another elastomeric, resilient material into an endless loop, and which are each operably connected by way of fasteners to a respective moveable support means which is shown in the form of a belt support frame. The belt support frame has an associated motor drive mechanism which is operable in use to cause the belt support frame to move, which in turn moves the conveyer belt strips through the interior of the magnetic treatment chamber. Each of the conveyer belt strips and its respective belt support frame and associated drive mechanism are mounted to a further structural frame which provides rigid support for these mechanisms, so that when movement of the conveyer belt strips occurs during use, the shape and configuration of the magnetising treatment chamber.

Each belt support frame comprises an endless loop of a support material in the form of metal strips or mesh or wires which are operably connected to at least two moveable support rollers about which the endless loop turns.

The first and second conveyer belt strips are arranged to be moveably displaceable in the same direction, as shown by the arrows adjacent thereto, as shown in FIG. 1 and FIG. 5. These conveyer belts are formed from a resilient, hard-wearing material of construction, capable of supporting abrasive finely powdered ore material as well as being resiliently flexible.

In use, the first conveyer belt 22 is moveably displaceable at a velocity which is faster than the velocity of the magnets 16 on their respective endless loop of support wires 38, which move independently of, but are surrounded by, the first conveyer belt 22.

The second conveyer belt 24 is moveably displaceable at a velocity which is faster than the velocity of the magnets 18 on their respective endless loop of support wires, which move independently of, but are surrounded by the second conveyer belt 24.

At the start of the process, and also between some stages, apparatus for comminution (or for progressive re-grinding) of solid particulate materials may be provided, in order to achieve liberation of valuable minerals from the surrounding gangue minerals found in an orebody, for example. In use, once the formerly oversize material has been subjected to dry grinding (for example, using a grinding mill), followed by a size separation process to deliver a pre-selected top-size of dry crushed feed material (for example using a vibrating screen, or the like), the undersize particulate material is able to be fed into the sequence of magnetisation treatment stages of the solids, to facilitate physical separation of the valuable particulate components.

In the case of a re-grind step of the particulate material conducted between magnetisation stages downstream in the process, the undersize material is returned to a suitable point upstream in the series of magnetic separation stages, for a further attempt at magnetisation of the solids, to facilitate physical separation of the valuable particulate components.

Based on experimental work using a magnetite orebody to separate magnetite, hematite and gangue minerals such as silica, the inventor believes that the design of magnetic separation stages can be operated satisfactorily with a feed particulate size distribution of p80% passing 200 μm (micrometres), which is considerably coarser than is usually used in prior art magnetic separators.

There are many ways to cause the rotational motion of the rollers. In one form, each roller is connected to a respective drive transmission mechanism to enable the roller to rotate about its own elongate axis, and each drive transmission mechanism is, in turn, connected in use to a motor drive to provide the energy for rotation, as will shortly be described. The drive transmission mechanisms and the rollers are mounted on a support in the form of an open frame structure, or at some other type of machine housing or structure.

### Operational Control System

A PLC-control system is used to manage roller rotational speed by taking feedback inputs from sensors which measure roller torque, roller load, roller surface condition, of both the endless loops carrying each of the upper and lower moveable magnetic sources, and both of the endless loops carrying the first and second surface elements.
The PLC-control system can also continuously monitor and then cause adjustment/regulation of the pre-determined lateral spatial distance between magnet pair surfaces, for example. Changing the proximity of magnets in pairs can be achieved by actuation of a mechanism to cause a change in the lateral spatial distance between one or both of the endless loops carrying the upper and lower moveable magnetic sources, and in some instances a similar change in lateral spatial distance can occur between one or both of the endless loops carrying the first and second surface elements.
The PLC-control system can also continuously monitor and then cause adjustment/regulation of the rotational speed of the support rollers, as well as to regulate the rate of input of solid particulates for magnetisation and separation, as necessary (for example by control of the rate and vibration of the vibratory feeder unit). The function of the PLC-control system is to maintain a thin layer of feed solids particulates on the support elements whilst also maximising throughput capacity of solids materials being separated in the machine, and avoiding the need to use external air to remove a build-up of particles, or to unblock a jam.
The PLC-control system can also monitor and control the temperature of the roller-bearings in the drive assembly housings, as well as automatically re-lubricate the roller-bearings in the drive assemblies.

### General Machine Construction

Modular construction of the machine allows any required number of magnetic separation stages to be added in a single stack, or multiple stages can be stacked, and those stacks can be located side-by-side and connected via bottom to top solids conveyer systems, so that the equipment does not become prohibitively tall. In any event, the stack(s) represent a more efficient use of limited floor space when compared with conventional separator technologies.

The machine provides easy side access via the side walls to the rollers themselves, to facilitate roller change-out and belt replacement, and to inspect the performance of the magnetic separation itself in producing three kinds of magnetisable product materials output.

The machine may have a dust-tight enclosure for the stacks of roller pairs/crushing stages, and also has one or more aspiration/gas extraction connections for de-dusting of the inside of the induction and separation treatment chamber, to remove and blockages caused by build-up of dust and fines. The connections can be located at strategic points about the equipment to provide both dust suppression and to facilitate removal of blockages, but in general the apparatus of the present invention has been designed to avoid the necessity for any air flow driven product separation stages, or for the removal of finely-sized final product as it is produced (nominally it will be as coarse as p80% passing 200 μm (micrometres), but this is dependent on the application).

### Solid Particulate Feed Input

Solid particulates are fed into the machine by way of a vibratory dosing chute or vibratory roller feeder or spreader onto the second surface element conveyer belt for transporting into the magnetic treatment chamber.

### Conveyer Belts

Conveyer belts used can have different material qualities such as hardness and durability, adapted as required for whatever product the machine is designed to carry, perhaps even including various roller surface corrugation forms and sizes. The belts used in the present invention may have various forms of central core belt reinforcement, such as wires or mesh arranged to extend over the length of the belt, and embedded through the middle of the belt thickness. An assessment of wear-and-tear at the conveyer surfaces is done during use by laser detector measurement prior to a maintenance changeout.

### EXPERIMENTAL SECTION

In essence, the technology fits into existing flowsheets to classify ground ore according to its magnetic susceptibility. Hence larger particles containing dilute quantities of unliberated grains of strongly magnetic material and other less magnetic materials are separated into a “middlings” stream. This stream is generally coarser in size than the feed and is recycled for further comminution.

The product stream captures the more liberated and strongly magnetic grains. This stream is also slightly coarser than the feed stream and that is one of the strengths of the technology—it is not necessary to grind the larger magnetite grains down to the P80 of all magnetite grains.

The tailings (gangue) stream is clean gangue containing dilute small magnetite and hematite grains in low concentrations within liberated gangue mineral grains. It therefore can be expected to have a lower P80 than the feed stream, but much of this is able to be rejected in the primary grinding stage and therefore at a size several times that of the magnetite liberation P80.

Finally, the inclusion of a cleaner process step allows for separation of a hematite rich stream for further ultrafine grinding and beneficiation to a hematite concentrate.

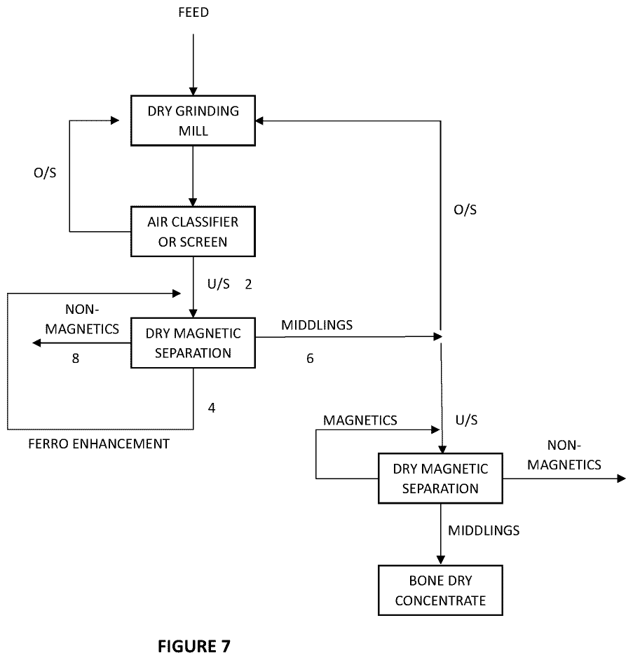

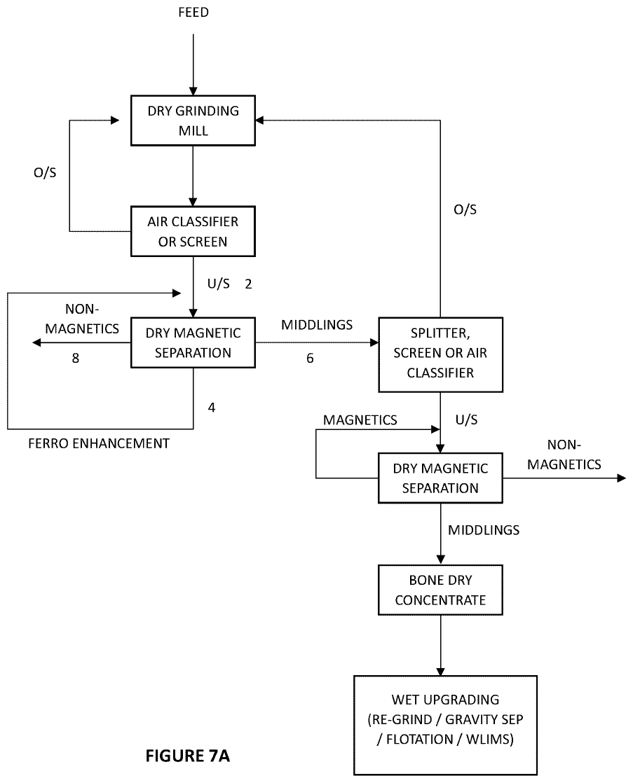

The flowcharts in FIG. 6, FIG. 6A and FIG. 7 refer to the following information:
1. Shown in FIG. 6 is the use of the Dry Magnetic Separator in the service of separating Magnetite. Shown in FIG. 6A, the dashed lines represent the addition of a hematite recovery process that also uses the Dry Magnetic Separator with Ferro Enhancement (most likely by recycled Magnetite).
2. Shown in FIG. 7 is the use of the Dry Magnetic Separator in the service of separating paramagnetic minerals from silica gangue and equally could be used for separating silica from unwanted paramagnetic minerals. Paramagnetic minerals to be targeted include: Ilmenite, Rutile, Wolframite, Chromite and various rare earth host minerals etc.

### Experimental Validation—Equipment

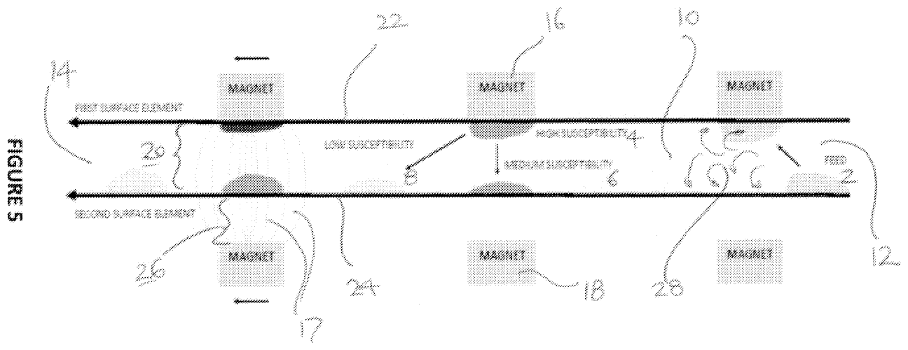

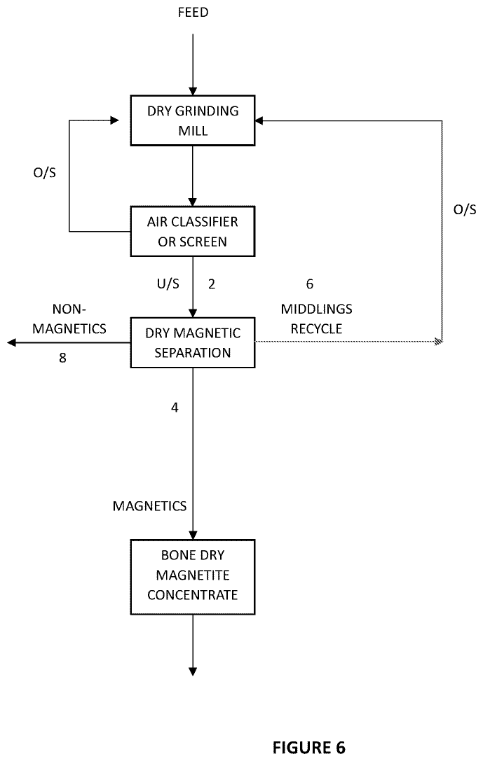

A laboratory scale version of the crushing machine has been constructed, and is as shown in FIG. 3 and FIG. 4.

The machine is of a scale model size. Exemplary solid particulate ore materials that had been pre-crushed were fed through this machine to simulate a finely crushed ore being processed.

At each experiment, measurements were taken of the usual equipment variable parameters, such as feed rate of particulate feed materials, belt speed, and ambient temperature. A pre-determined lateral distance between the respective pairs of magnets on either side of the treatment zone between the upper and lower belts was selected from past experience. The results are summarised in the following Tables.

### Experimental Validation—Results Data

TABLE 1
Feed Sample Properties

| | P80 | Feed | | Iron Deportment (XRD) | | |
|---|---|---|---|---|---|---|
| Sample | (μm) | wt % Fe | DTR % | Magnetite | Hematite | Gangue |
| 1 | 195 | 22.3% | 39% | 55% | 27% | 18% |
| 2 | 80 | 54.8% | | 91% | 8% | 1% |
| 3 | 37 | 27.4% | 24% | 60% | 24% | 16% |
| 4 | 35 | 22.6% | 25% | 69% | 5% | 26% |

TABLE 2
Test Parameters

| | Feed | Speeds (Hz) | | | Ambient | |
|---|---|---|---|---|---|---|
| Sample | Rate | Mag | Belt 1 | Belt 2 | ° C. | RH % |
| 1 | 50 | 7 | 32 | 9 | 17 | 45% |
| 2 | 38 | 7 | 32 | 9 | 14 | 51% |
| 3 | 67 | 7 | 32 | 9 | 26 | 63% |
| 4 | 64 | 7 | 32 | 9 | 26 | 63% |

TABLE 3
Test Results

| | Concentrate | | Middlings | | Tailings | | Iron | Dust |
|---|---|---|---|---|---|---|---|---|
| Sample | wt % Fe | Recovery | wt % Fe | Recovery | wt % Fe | Recovery | Recovery | loss |
| 1 | 38.9% | 27.1% | 21.7% | 25.0% | 11.4% | 47.3% | 71.6% | 0.6% |
| 2 | 72.0% | 52.0% | 62.8% | 26.8% | 2.5% | 21.2% | 97.4% | 0.0% |
| 3 | 49.0% | 23.0% | 29.3% | 29.0% | 15.2% | 46.9% | 72.2% | 1.1% |
| 4 | 58.6% | 22.9% | 26.8% | 16.5% | 7.1% | 58.1% | 78.9% | 2.5% |

### Experimental Validation—Conclusions from Results Data

The following are some of the main conclusions from the test results provided herewith:
1. When a coarse sample such as Sample 1 is treated, the technology is able to recover similar concentrate as would be recovered in a DTR test as well as producing a middlings stream of hematite and very low liberation magnetite for regrinding whilst expelling a tailings stream with iron only approximating that of the gangue minerals (i.e. with minimal loss of recoverable iron). It is predicted that in a full grinding recycle test the concentrate grade achieved would reach >67% once steady state is achieved.
2. When a fully liberated ore such as sample 2 is treated, the technology can achieve high recovery and near pure magnetite product. The less liberated and hematite can be recovered to the middlings for further grinding to liberation.
3. When a fine and almost liberated stream is treated to a single pass the technology is able to recover similar concentrate as would be recovered in a DTR test as well as a middlings stream of unliberated magnetite and hematite for further grinding whilst expelling a tailings stream with very low loss of recoverable iron.
4. Testing suggests recovery of hematite is achieved. However, the hematite grain size is generally smaller than that of magnetite in the samples tested, hence further testing is to be undertaken with respect to hematite liberation and separation.
5. Dust losses are very low for the prototype unit even though the unit was narrow and the sides were not fully enclosed. As the ratio of working area to the side length increases for a commercial scale unit the dust losses are predicted to diminish to negligible, particularly given side curtains would be added. This supports the contention that no dust system and bag house is required.
6. Several tests were conducted at relative humidity of above 60%. Dry systems can suffer reduced performance at high humidity. Testing showed no indication of performance degradation.

### CONCLUSIONS

Details of a magnetic separation technology incorporating several novel innovations, has been presented. The technology addresses the issue of overgrinding of solid particulate materials during crushing, by showing a process which can operate at a much coarser average particle size to achieve separation, with the net result being a commensurate reduction in the amount of energy consumed. The comminution machine disclosed herein has many advantages over other particle separation technologies:
Because the machine is designed to provide the aforementioned magnetic separation at coarse sizes, it avoids the typical over-grinding of a large portion of the feed material down to a size which is below the minimum product size needed (for example, for mineral liberation from an ore). By keeping particle size coarse, this can also minimise (or even eliminate) the requirement for an air classifier to remove ultrafine particulates, as compared with other processes which try to handle an orebody which was produced during overgrinding.
Also, because the machine is designed to provide magnetic separation at an average coarse particle size by avoiding over-grinding of a large portion of the feed material, it can therefore achieve substantial reductions in energy usage. The inventor projects that use of the novel machine can obviate the need for 40% of the energy of conventional production crushing and milling equipment which is normally needed when reducing particle size from the present p80% passing 200 μm size which has been demonstrated can achieve good separation, down further to the typical practice of grinding to a p80% passing 100 μm crushed ore, or even as little as a final product size of p80% passing 45 μm (0.045 mm).

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “upper” and “lower”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The preceding description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments of the inventions, and alterations, modifications, additions and/or changes can be made thereto without departing from the scope and spirit of the disclosed embodiments, the embodiments being illustrative and not restrictive.

Furthermore, the inventions have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realise yet other embodiments. Further, each independent feature or component of any given assembly may constitute an additional embodiment.

1-27. (canceled)

28. An apparatus arranged for inducing magnetism in a flowstream of at least partially magnetisable, dry particulate feed material, in order to effect a subsequent particle classification thereof, in use the flowstream being fed into a dry separation stage which is located proximal to said magnetic induction apparatus, the apparatus comprising:
a treatment chamber with an inlet and an outlet, through which the flowstream respectively enters and exits the treatment chamber; and
a plurality of spaced-apart magnetic sources located adjacent to, and moveably displaceable in the same direction along the length of both an upper and a lower side region of the treatment chamber, such that, during said movement, a respective magnetic source from each of the upper and lower side regions forms a pair of magnetic sources which are aligned in opposing relation to one another, and laterally spatially positioned apart with respect to one another, in use each of said pairs of magnetic sources generating a localised magnetic induction field zone; and
said upper side region of the treatment chamber being defined by at least one of a moveable first surface element which is configured in use to move over a face of said spaced-apart magnetic sources which are located thereabove, and said lower side region of the treatment chamber being defined by at least one of a moveable second surface element which is configured in use to move over a face of the spaced-apart magnetic sources which are located therebelow;
wherein during operation of the apparatus:
the second surface element transports the flowstream of dry particulates into the treatment chamber via the inlet; and
once inside the treatment chamber, the relative rate of motion of the first surface element with respect to the magnetic sources at the upper side region of the chamber is greater than the relative rate of motion of the second surface element with respect to the magnetic sources at the lower side region of the chamber, thereby creating a region of air-particle fluidisation and agitation within the treatment chamber due to physical separation of the particulate feed material from the second surface element; and
the combined effect of air-particle fluidisation and agitation during exposure to said localised magnetic induction field zones generated by said respective pairs of magnetic sources, results in a physical classification of said particulates, based upon their susceptibility to magnetic induction, such that:
a feed material fraction with high susceptibility to magnetisation is retained at the first surface element due to a preferential attraction to the spaced-apart magnetic sources which are located at the upper side region of the treatment chamber;
a feed material fraction with medium susceptibility to magnetisation is repelled by the pairs of spaced-apart magnetic sources which are located at both the upper and lower side regions of the treatment chamber, ultimately is retained at the second surface element in the regions of low magnetic intensity located between the pairs of spaced-apart magnetic sources in the treatment chamber; and
a feed material fraction with low susceptibility to magnetisation is ultimately retained at the second surface element in a region adjacent the spaced-apart magnetic sources which are located at the lower side region of the treatment chamber to which it is attracted, as well as due to repulsion by the spaced-apart magnetic sources which are located at the upper side region of the treatment chamber.

29. An apparatus as claimed in claim 28, wherein the plurality of spaced-apart magnetic sources located adjacent to both the upper and lower side regions of the treatment chamber are respectively operably coplanar whilst being laterally spatially positioned apart, in use.

30. An apparatus as claimed in claim 28, wherein the plurality of spaced-apart magnetic sources are connected to a respective moveable support element, operable in use to move the magnetic sources along the length of the upper and/or lower side regions of the treatment chamber by means of an associated drive mechanism, wherein the moveable support element(s) and associated drive mechanism(s) are connected to a frame which is positioned in fixed relation to the treatment chamber.

31. An apparatus as claimed in claim 30, wherein at least one of the moveable support elements is operably moveable by means of an adjustment mechanism, in use to adjust the lateral spatial distance between the magnetic sources which are aligned in opposing relation with respect to one another at the treatment chamber, to thereby reduce the intensity of the localised magnetic field zones thereat.

32. An apparatus as claimed in claim 30, wherein the moveable support element used to move the magnetic sources along the length of the lower side region of the treatment chamber is operably moveable by means of an adjustment mechanism, in use to adjust the lateral spatial distance of those magnetic sources with respect to the second surface element, to thereby reduce the intensity of the localised magnetic field zone experienced at the second surface element.

33. An apparatus as claimed in claim 30, wherein the plurality of pairs of magnetic sources which are aligned in opposing relation with respect to one another at the treatment chamber, and which deliver the highest intensity of localised magnetic field zones thereat, are spaced at a pre-determined distance apart from an adjacent magnetic source along the length of each respective moveable support element such that in use, a zone of relatively low magnetic intensity is operably achieved midway along that predetermined distance between each of the adjacent magnetic sources.

34. An apparatus as claimed in claim 30, wherein each moveable support element comprises an endless loop of a support material which is operably connected to at least two moveable support roller(s) about which the endless loop turns, and wherein each endless loop is operated by the associated drive mechanism in use.

35. An apparatus as claimed in claim 28, wherein the plurality of spaced-apart magnetic sources located adjacent to the upper and the lower side regions of the treatment chamber are moveably displaceable at the same relative rate of motion, in use.

36. An apparatus as claimed in claim 28, wherein the maximum lateral spatial distance between the first and second surface elements with respect to one another is determined by the spatial position of the plurality of magnetic sources at the upper and lower side regions of the treatment chamber, since the respective first and second surface elements are arranged to slidingly move over an exposed face of each magnetic source.

37. An apparatus as claimed in claim 28, wherein the, or each, first and second surface elements comprise an endless loop which is operably connected to a respective moveable support means, operable in use to move the surface elements along the length of the upper and/or lower side regions of the treatment chamber by means of an associated surface element drive mechanism, wherein the moveable support means and associated drive mechanism are connected to a frame which is positioned in fixed relation to the treatment chamber.

38. An apparatus as claimed in claim 37, wherein each moveable support means comprises an endless loop of a support material which is operably connected to at least two moveable support roller(s) about which the endless loop turns, and wherein each endless loop is operated by the associated surface element drive mechanism in use.

39. An apparatus as claimed in claim 28, wherein the, or each, first and second surface elements are moveably displaceable in the same direction, in use.

40. An apparatus as claimed in claim 28, wherein the, or each, first and second surface elements are formed from a resilient, hard-wearing material of construction, capable of supporting abrasive finely powdered ore material.

41. An apparatus as claimed claim 28, wherein the, or each of the, first surface element(s) is moveably displaceable at a rate of motion which is approximately 0.2-1.0 metres/second faster than the rate of motion of the spaced apart magnetic sources at the upper side region of the treatment chamber and optionally wherein the, or each of the, second surface element(s) is moveably displaceable at a rate of motion which is approximately 0.0-0.2 metres/second faster than the rate of motion of the spaced apart magnetic sources at the lower side region of the treatment chamber.

42. An apparatus as claimed in claim 28, wherein the plurality of spaced-apart magnetic sources includes at least one of: permanent magnetic materials; and sources formed of electromagnetic materials which are externally powered in order to induce magnetism, in use.

43. An apparatus as claimed in claim 28, wherein the feed material fraction with high susceptibility to magnetisation includes ferromagnetic particulate materials, the feed material fraction with medium susceptibility to magnetisation includes paramagnetic particulate materials, and the feed material fraction with low susceptibility to magnetisation includes diamagnetic particulate materials and optionally wherein the feed material fraction with low susceptibility to magnetisation may include diamagnetic particulate materials which also contain unliberated ferromagnetic and/or paramagnetic material therewithin.

44. An apparatus as claimed in claim 28, wherein the feed material fraction with high susceptibility to magnetisation is caused to be physically separated from the first surface element in a region outside of the treatment chamber, and once there are no spaced-apart magnetic sources located adjacent thereto.

45. An apparatus as claimed in claim 28, wherein the feed material fraction with medium susceptibility to magnetisation is caused to be physically separated from the second surface element in a region outside of the treatment chamber, and once there are no spaced-apart magnetic sources located adjacent thereto.

46. An apparatus as claimed in claim 28, wherein the feed material fraction with low susceptibility to magnetisation is caused to be physically separated from the second surface element in a region adjacent to, but outside of the exit of the treatment chamber, where the endless loop turns to travel in an opposite direction.

47. A method for inducing magnetism in a flowstream of at least partially magnetisable, dry particulate feed material, and effecting a subsequent particle classification thereof using a dry separation apparatus which is located proximal to a magnetic induction apparatus, wherein said apparatus comprises:
a treatment chamber with an inlet and an outlet, through which said flowstream respectively enters and exits the treatment chamber in use; and
a plurality of spaced-apart magnetic sources located adjacent to, and moveably displaceable in the same direction along the length of, both an upper and a lower side region of the treatment chamber, arranged in use so that when pairs of laterally separated magnetic sources, one from each of said upper and lower side regions, are located in opposing facing alignment with one another, a localised magnetic induction field zone is generated therebetween; and
a first surface element which, in use, moves over faces of the plurality of spaced-apart magnetic sources located at the upper side region, and a second surface element which, in use, moves over faces of the plurality of spaced-apart magnetic sources located at the lower side region;
the method comprising the steps of:
following a transfer of particulate feed material onto the second surface element, causing said second surface element to transport said flowstream of particulate feed material into the treatment chamber via the inlet; and
setting the rates of motion of
(a) the first surface element
(b) the magnetic sources at the upper side region of the chamber,
(c) the second surface element, and
(d) the magnetic sources at the lower side region of the chamber,
so that the relative rate of (a) to (b) is greater than the relative rate of (c) to (d), thereby creating region(s) of air-particle fluidisation and agitation within the treatment chamber, due to physical separation of the particulate feed material from the second surface element;
wherein the combined effect of air-particle fluidisation and agitation during exposure to said localised magnetic induction field zones generated by said respective pairs of magnetic sources, results in a physical classification of said particulates, based upon their susceptibility to magnetic induction, such that:
a feed material fraction with high susceptibility to magnetisation is retained at the first surface element due to a preferential attraction to the spaced-apart magnetic sources which are located at the upper side region of the treatment chamber;
a feed material fraction with medium susceptibility to magnetisation is repelled by the pairs of spaced-apart magnetic sources which are located at both the upper and lower side regions of the treatment chamber, and ultimately is retained at the second surface element in a region of low magnetic intensity located between the pairs of spaced-apart magnetic sources in the treatment chamber; and
a feed material fraction with low susceptibility to magnetisation is ultimately retained at the second surface element in a region adjacent the spaced-apart magnetic sources which are located at the lower side region of the treatment chamber to which it is attracted, as well as due to its repulsion by the spaced-apart magnetic sources which are located at the upper side region of the treatment chamber.
